(19) United States
(12) Patent Application Publication
(10) Pub. No.: US 2026/0249890 A1
(43) Pub. Date: Aug. 27, 2026

(54) METHOD AND SYSTEM FOR COOLING A TRACTION COMPONENT OF A RAIL VEHICLE

(71) Applicant: Siemens Mobility GmbH, München (DE)

(72) Inventors: Alexander Dorsch, Nürnberg (DE); Bernd Vangermain, Erlangen (DE)

(21) Appl. No.: 18/878,228

(22) PCT Filed: Jun. 6, 2023
(86) PCT No.: PCT/EP2023/065115

§ 371 Date: Dec. 23, 2024

(30) Foreign Application Priority Data
Jun. 21, 2022 (DE) 10 2022 206 177.2

(51) Int. Cl. B61L 15/00

(52) U.S. Cl. CPC B61L 15/0058; B61L 15/0081

(57) ABSTRACT

A method for cooling a traction component of a rail vehicle during its journey on a route includes providing journey information relating to the route, including data on an expected power consumption of the traction component during the journey at different times, or including data from which the expected power consumption can be calculated. The temperature of the traction component is measured during the journey at a first time. A cooling power is calculated based on the measured temperature and the expected power consumption of the traction component on a section of the route, through which the rail vehicle will travel after the first time. The traction component is cooled with the calculated cooling power. A system, a cooling system, a rail vehicle, a computer program product and a computer-readable storage medium, are also provided.

The invention relates to a method and a system for cooling a traction component of a rail vehicle, in particular a locomotive, a railcar, or a multiple unit train, during its journey on a route, in particular to save energy and/or increase the availability of the maximum power by a selection of the cooling strategy, for example, by targeted “precooling”.

The cooling system of the traction system of a locomotive is typically designed for the worst possible case. This means that during the design and conception phase of the locomotive, component tolerances, external conditions, and assumed operating points are always selected so that the most unfavorable state for the operation and therefore the components is assumed as the basis for calculations and simulations. The components of the locomotive are specified and therefore their properties such as thermal time constants and thermal load limits are defined on this basis. The required performance of the cooling system is determined based on these properties and the primary goal of component protection. This also applies to other driven rail vehicles, such as railcars or multiple unit trains.

The control of the cooling system is carried out on the basis of the input or calculated temperatures of the traction components to be cooled. The required cooling demand is ascertained on the basis of this component temperature and set accordingly via the controller at the actuators of the cooling system. The parameterization of the controller has to be selected here so that the following requirements are met in the best possible manner (in descending priority):
1. Service life: thermal protection of the components
2. Availability: provision of the vehicle performance under all external circumstances
3. Energy efficiency: optimum (usually minimum) power consumption of the cooling components.

Requirements 1. and 3. are contrary requirements. To meet requirement 1., a high cooling power is always to be provided, whereas requirement 3. requires the lowest possible cooling power. Since only the thermal status of the traction components recorded at the moment is present for the determination of the cooling demand by the controller, it is difficult to ascertain a parameterization of the cooling control, by means of which all requirements are met equally. Due to the prioritization, the parameterization of the cooling system control can usually be selected so that the protection of the components is ensured.

This disadvantageously has the result that the components and their cooling system are not optimally used at part load and therefore in a variety of usage scenarios and the control maintains large reserves.

The control of current cooling systems relates exclusively to the currently measured temperature of the components to be cooled. The measured or calculated temperatures are compared to previously defined parameters, which map a dependence of component temperature to cooling demand in the form of a fan speed/frequency, and the resulting fan speed is set at the fan.

It is an object of the present invention to specify an alternative, more comfortable method and a corresponding system for cooling a traction component of a (driven) rail vehicle during its journey on a route, by means of which the above-described disadvantages are avoided and in particular energy is saved or the availability of the maximum performance is increased.

This object is achieved by a method as claimed in claim 1, a system as claimed in claim 10, and a cooling system as claimed in claim 12 and a rail vehicle as claimed in claim 13.

The method according to the invention is used for cooling a traction component of a (driven) rail vehicle, which means in particular a locomotive, a railcar, or a multiple unit train, a subway train, or in general a battery-operated rail vehicle as well as a diesel vehicle or fuel-cell vehicle, during its journey on a route. A traction component means a component which is used directly for the journey of the rail vehicle, such as a converter or a motor. As stated above, suitable cooling systems are fundamentally known, however, they are actuated here in a special manner and therefore the cooling is optimized. The method comprises the following steps:
providing journey information on the route, which comprises data on a power consumption of the traction component to be expected during the journey at various times or comprises data from which this power consumption to be expected is calculable or can be calculated,
measuring the temperature of the traction component during the journey at a first time,
calculating a cooling power based on the measured temperature (thus based on recorded temperature data) and the power consumption of the traction component to be expected on a section of the route which the rail vehicle will travel through after the first time,
cooling the traction component using the calculated cooling power.

The journey information comprises data on the current journey of the rail vehicle. It gives information about which power the traction component will consume at future times on the journey. These can be direct data on the power consumption, or data from which the power consumption can be derived, for example, data of the group for characterizing the journey or the route comprising uphill gradients, down-hill gradients, curve radii, stops, accelerations, and decelerations. Data on the cargo of the carriages moved by the rail vehicle during the journey can also be included. It is important that the power consumed on the journey is known at various times, preferably at a large number of times over the entire journey. The provision can be carried out by a control center, for example, via radio or another type of data communication, or also from a data memory. For example, the journey information can be a value table or a graph which indicates the power consumption.

The measurement of the temperature of the traction component during the journey is already implemented in many (driven) rail vehicles and is known to a person skilled in the art. Temperature sensors, with which many rail vehicles are already equipped, can be used for this purpose. The temperature measurement takes place at a first time. This means a time during the journey which is in principle an arbitrary time and to which the following method sequence relates. It is to be noted that the method is applicable or can be applied progressively during the journey, wherein preferably the current time of a measurement is considered to be the respective “first time”.

A cooling power is now ascertained from the journey information for a following section of the route (“route section”), in relation to the position of the rail vehicle on the route at the first time. This route section preferably immediately follows the position of the rail vehicle at the first time, but theoretically can also only follow later. Since the cooling is observed here, it is preferred for the route section to be preferably large enough that the rail vehicle travels through it in a time span longer than one minute, in particular longer than 5 minutes. However, it is also preferred for the route section to be large enough that the rail vehicle travels through it in a time span shorter than one hour, in particular shorter than 30 minutes or even in less than 15 minutes. The term “immediately” relates here to the data of the journey information. If these are provided, for example, in the form of a table or a graph, then preferably the part of the table or the graph is used which immediately follows the first time with regard to the journey of the rail vehicle.

It is to be noted for this purpose that the journey information is generally route-related. In practice, it is preferred to determine the position of the rail vehicle on the route in this step at the first time, for example, by means of GPS or balises, and in particular also to determine the velocity of the rail vehicle. It is then ascertained which data set of the journey information is relevant for the following method step, thus can be associated with said route section. This preferably takes place so that after the position of the rail vehicle on the route is ascertained, a data set is selected from the journey information which corresponds to a following section of the route (having possibly predetermined length), wherein the data set can also be ascertained based on the current velocity, thus the route section and/or the data set to be used is determined depending on the velocity. A power consumption to be expected (in the route section) can be ascertained from this data set, for example, a greater one if the following route ascends and a smaller one if it continues flat.

The cooling power is then calculated based on the measured temperature and the power consumption to be expected. If an incline follows, the cooling power can already be increased beforehand or remain the same, for example, if the following route section extends flat. Particularly advantageous scenarios for the calculation of the cooling power are described hereinafter. However, it is important that not only current temperature data are used to control the cooling (thus for the cooling power), but also data on the following route.

The cooling of a traction component is fundamentally known. However, the specially calculated cooling power, which is based, inter alia, on data for the following route, is now used in the scope of the invention. It is to be noted that many known systems for cooling simply require a specification for the cooling power. In general, the term “cooling power” means everything which causes a cooling function to cool with the desired cooling power. These can be numeric values, control commands, cooling graphs, or other data or signals.

In contrast to the prior art, in which only the current component temperature is incorporated into the control of the cooling system, now a recommended driving style (or other route information) is taken into consideration as a further input for the control of the system.

In addition to the actual temperatures of the components, the future load profile of the rail vehicle on the basis of the known route and the driving plan to be traveled can be incorporated into the ascertainment of the required cooling demand and therefore the fan frequency to be set.

A system according to the invention for cooling a traction component of a rail vehicle during its journey on a route is in particular designed to carry out the method according to the invention. The system comprises the following components:
a data interface designed for receiving journey information on the route, which comprises data on a power consumption of the traction component to be expected during the journey at various times or comprises data from which this power consumption to be expected is calculable or can be calculated,
a measuring unit designed for measuring the temperature of the traction component during the journey at a first time,
a computing unit designed for calculating a cooling power based on the measured temperature and the power consumption of the traction component to be expected on a section of the route through which the rail vehicle will travel after the first time,
a control unit designed for controlling a cooling unit of the rail vehicle to cool the traction component using the calculated cooling power.

Suitable data interfaces are known and are designed in particular for data communication via radio or to a memory unit.

Suitable measuring units are known in the prior art. Measuring units as already monitor a cooling unit in a (driven) rail vehicle can be used for this purpose.

The computing unit has to be designed for calculating the cooling power based on the measured temperature and the power consumption to be expected. For example, it is a computer or a controller designed for calculating capacity values (or control data) from measured temperature data and the above-mentioned data set from the journey information.

Suitable control units are fundamentally known in the prior art and are used to control a cooling unit. It is important that the control unit operates the cooling unit using the calculated cooling power.

The cooling system according to the invention for a rail vehicle comprises a cooling unit and a system according to the invention. It is to be noted that the system controls the cooling unit using its control unit. The cooling unit thus cools according to the calculated cooling power.

Suitable cooling units are known in the prior art and are used in (driven) rail vehicles such as locomotives, railcars, or multiple unit trains for cooling the traction components.

A rail vehicle according to the invention, in particular a multiple unit train, a railcar, or a locomotive, comprises a cooling system according to the invention.

The invention can be implemented in particular in the form of a computer unit, in particular in a control device, having suitable software. The computer unit can have, for example, one or more cooperating microprocessors or the like for this purpose. In particular, it can be implemented in the form of suitable software program parts in the computer unit. An implementation largely in software has the advantage that computer units which are already previously used in multiple unit trains or block trains or in their carriages can be retrofitted easily by a software or firmware update in order to operate in the manner according to the invention. The object is in this respect also achieved by a corresponding computer program product having a computer program which is loadable directly into a memory device of a computer unit, having program sections to carry out all steps of the method according to the invention when the program is executed in the computer unit. Such a computer program product can possibly comprise additional parts in addition to the computer program, such as documentation and/or additional components, also hardware components, such as hardware keys (dongles, etc.) for using the software. For the transport to the computer unit and/or for the storage on or in the computer unit, a computer-readable medium, for example, a memory stick, a hard drive, or another transportable or permanently installed data carrier, can be used, on which the program sections of the computer program that can be read and executed by a computer unit are stored.

Further, particularly advantageous embodiments and refinements of the invention will be apparent from the dependent claims and the following description, wherein the claims of a claim category can also be refined analogously to the claims and parts of the description on another claim category and in particular also individual features of various exemplary embodiments or variants can be combined to form new exemplary embodiments or variants.

According to one preferred method, special journey information is used. The journey information preferably comprises data on a route profile, in particular on the incline, the downhill gradient, the height, and the length of a route section, and on curve radii. Alternatively or additionally, the journey information preferably comprises data on a driving plan, in particular having route-dependent accelerations, decelerations, and stops or times and durations of standstill times. Alternatively or additionally, the journey information preferably comprises data on a recommended driving style, in particular a velocity profile, preferably energy-optimized or power-optimized. Alternatively or additionally, the journey information preferably comprises data on a cooling demand which will be required at a future time. Alternatively or additionally, the journey information preferably comprises data on a trailer load and/or vehicle cargo. Alternatively or additionally, the journey information preferably comprises data on meteorological ambient conditions, in particular on wind and/or temperature. Alternatively or additionally, the journey information preferably comprises data on the energy of an energy carrier still available for the journey of the rail vehicle, in particular the fill level of a tank, for example, of hydrogen or diesel, or a battery (for example, the state of charge of the battery).

According to one preferred method, a cooling power curve for the control of the cooling power over a period of time is provided before or during the journey. This cooling power curve can also be referred to as a “cooling characteristic curve” or more generally as a “cooling strategy” and in particular comprises frequency specifications and/or other cooling specifications for the operation of a cooling unit (for the traction component). It is preferred here that a predetermined cooling power curve is modified based on the journey information and the measured temperature. Alternatively, a cooling power curve can preferably be calculated based on the journey information and the measured temperature and in particular an existing cooling power curve can be replaced. Alternatively, a cooling power curve can preferably be selected based on the journey information and the measured temperature from a group of cooling power curves and in particular an existing cooling power curve can be replaced. Preferably, the cooling of the traction component is continued after the first time according to the cooling power curve. This has the advantage of not having a static value for a cooling function, but rather a profile which changes with time.

It is to be noted that the journey information F can be correlated with various cooling power curves. This preferred embodiment can already specify which cooling power curve is to be applied during which route section or in which driving situation.

According to one preferred method, the journey information comprises data on the number of stops and standstill times, or such journey information is used. A cooling power curve for cooling the traction component is created in consideration of a cooling function during a following standstill time. Preferably, the cooling power curve is created here in such a way that the temperature of the traction component after the downtime corresponds to a predetermined target temperature.

A predetermined cooling power curve for the cooling is preferably modified in such a way that the cooling is reduced during the journey and the cooling is extended into the downtime.

This embodiment is particularly advantageous for a rail vehicle which is operated over a longer period of time at high power. The cooling system normally operates in this case at the maximum level in the prior art in order to keep the components as cool as possible. In this way, the attempt is made to keep the reserves to the maximum permitted temperature as large as possible in the traction system in order to always be able to effectuate possible further performance increases without reduction (due to excess temperature). In the case that a longer stay is planned for the rail vehicle at the next stop, the locomotive is then parked with cool components in the prior art, although the components could cool down independently without an active cooling system at a standstill. The energy which is applied before the standstill for the cooling in the prior art would be saved by the preferred embodiment described above in the case in which a longer standstill time is planned in any case for the rail vehicle according to the specification by the driving plan (in the journey information). The control of the planned standstill (in a following route section) is known due to the evaluation of the driving plan. The fan strategy (frequency and voltage specification of the converter) is adapted accordingly by the specifications of the required cooling power.

Using the information on the planned standstill of the rail vehicle, including the intended downtime (in the journey information), the cooling power is reduced during the preceding journey enough that the downtime is taken into consideration. The rail vehicle can certainly manage with warmer traction components than in the prior art, possibly even with hot traction components, at the stopping point. The intended time of the standstill is then used for cooling the traction system. Only very little to no additional power has to be applied in the standstill for the cooling of the components by the fans and pumps. Due to the incorporation of the driving plan in the determination of the cooling strategy and the dynamic utilization of thermal reserves of the components, the power which has to be provided for the cooling system can be reduced. As a result, the energy efficiency of the cooling system and therefore of the entire rail vehicle is improved.

According to one preferred method, the journey information comprises data on a route profile (or such journey information is used) and route sections which require a high power output are identified in the route profile. Before reaching such a route section, a cooling power curve for cooling the traction component is then created, which precools the traction component before reaching the relevant route section. The cooling power curve is preferably created in such a way that the temperature of the traction component is below a predetermined starting temperature (for the start of the journey through this route section) before reaching the relevant route section. The starting temperature can be predetermined by the temperature which should optimally exist at the beginning of the journey through this route section in order to avoid overheating of the traction components.

A predetermined cooling power curve for the cooling is particularly preferably modified in such a way that the cooling power is already increased before reaching the relevant route section.

This embodiment is particularly advantageous for a rail vehicle for which the load of the traction system is initially only moderate, for example, because it travels in a straight line on a flat route. The temperature of the components is typically increased somewhat here and the cooling system operates at a low level. If the rail vehicle subsequently travels into an incline, in the prior art, the ventilation function would increase the frequency of the fans accordingly due to the rising component temperatures (due to the increased traction demand). For this case of the higher traction demand, a reserve is retained in the thermal design of the components.

The reserve is selected so that an increase of the requested power can be served at any time. To avoid overdesign of the components, a compromise has to be made in the determination of the reserve between actual demand in operation and production price. In this way, the time until the limiting temperature of the components is reached and a reduction of the traction power takes place is finite. This can have the result that performance losses occur during long steep passages in the prior art. How long the reserves last until the maximum component temperature is substantially dependent on external temperature, traction force, and velocity.

The above-described preferred embodiment is particularly advantageous if high temperatures of the traction components threaten on a future route section (possibly in particular in the case of high external temperatures), for example, during journeys with high trailer load in very long and steeply rising route sections. Route sections which according to the journey information have a large incline or curve radius and length (large in relation to a defined limiting value) or route sections which require a high power output are identified and the cooling strategy is automatically adapted in this case. For the exemplary case that a longer uphill slope is upcoming, the cooling power of the system is already increased before reaching the incline enough that the traction components are in a precooled state. This preconditioning increases the thermal reserve which is ready for the upcoming region having increased power output and therefore lengthens the time in which the maximum power can be retrieved without thermal restriction. The prior identification of route sections with high power requirement due to route slope, trailer load, or driving plan specification increases the availability of the power of the rail vehicle.

According to one preferred method, the journey information comprises data on energy still available for the journey and additionally data from which an energy consumption for the further journey can be derived (or such journey information is used). These are in particular data on a route profile and/or a trailer load and/or a velocity profile. A cooling power curve for cooling the traction component is then created in such a way that the available energy is not exceeded before completion of the journey.

According to one preferred method, it is calculated which residual energy will still be available at the end of the journey. If the residual energy falls below a predetermined limiting value, a velocity profile is ascertained which has a lower energy consumption than a velocity profile applied for the journey and this ascertained velocity profile is applied for the further journey or output as a driving recommendation for a locomotive driver. Alternatively or additionally, if the residual energy falls below a predetermined limiting value, a cooling power curve for cooling the traction component is created in such a way that a predetermined minimum cooling takes place and thermal reserves of the traction component are utilized.

The above-described preferred embodiment is particularly advantageous if a rail vehicle is operated using an integrated high-voltage traction battery (HV battery). The rail vehicle is typically set into a specific mode for this operation. In this mode, the actuation of the auxiliary operations is designed for low energy consumption, for example, by reducing fan frequencies. The energy stored in the battery decreases due to the operation of the cooling function and therefore the route which can be covered by the rail vehicle decreases.

The range is dependent on the route to be traveled, the total mass of the vehicle, and the driving style of the multiple unit train driver. In the prior art, this driver only has the displayed remaining range or battery capacity only as a guide on which the multiple unit driver can orient his driving style.

The previous determination of the remaining range during the operation of the rail vehicle from an HV battery is primarily based on the previously consumed energy and the average consumption per minute or kilometer thus calculated. Only a rough statement can thus be made for the further journey as to whether the planned driving plan will be met or the stopping point will be reached using the remaining available energy, for example, the still existing fuel or the existing battery capacity, since no upcoming route requirements are incorporated into the calculation.

Using the above-described preferred embodiment, it is possible to significantly increase the accuracy of the calculation of the remaining range. A higher energy consumption due to route characteristics (curve radius, slope, distance to the destination) is preferably also incorporated here into the calculation, as well as the requirements due to the predetermined driving plan. To increase the range using the existing state of charge of the battery, an energy-optimal driving style is specified as a driving recommendation to the multiple unit train driver. For example, if it is recognized due to the comparison of driving route, driving style, and remaining energy, for example, the battery residual capacity, that a destination stopping point cannot be reached, the capacity of the cooling system is automatically reduced, for example, to a minimum. This can in particular take place with utilization of all thermal reserves of the traction components which are known. The remaining range is thus maximized. It is also preferred for the method to be designed so that proposals for an adapted driving style are generated and output to the driver, for example, proposals for the extent to which the driving style or the maximum velocity would have to be adapted so that the vehicle is capable of completing the route journey. With this preferred embodiment, the cooling strategy is particularly preferably adapted based on the route characteristics in the scope of the thermal reserves of the traction components so that operating duration and route which is possible using a battery charge is maximized as much as possible.

A preferred system comprises a sensor for measuring the external temperature, wherein the computing unit is designed to additionally calculate a cooling power based on a measured external temperature.

A preferred system comprises a sensor for measuring energy stored in a battery of the rail vehicle, wherein the computing unit is designed to additionally calculate a cooling power based on a measured energy stored in the battery.

The invention has the advantage of optimized cooling. Depending on which data are available in the journey information and are used, very particular advantages result in typical journey scenarios.

For example, the above-described thermal preconditioning of components enables a higher availability of the maximum performance of the rail vehicle. In comparison to the currently used cooling system control, it is possible to react flexibly here to the requirement due to the driving route and the performance availability can be adapted energy efficiently for each route section.

By means of the invention, energy is saved during the operation of the rail vehicle, which directly results in a reduction of the operating costs.

The invention can also ensure that the cooling system is actuated individually for each driving route so that the characteristics of the route and the driving plan (hill descents, flat track areas with low power requirement, standstill times, etc.) are optimally utilized. It is therefore ensured that the components are thermally protected, thus are cooled sufficiently that the vehicle electrical system draws as little energy as possible in this case. Moreover, the possible range or operating duration from an HV battery is maximized by an increase of the energy efficiency of the rail vehicle.

If an HV battery is used, the energy stored therein is utilized optimally, i.e., the rail vehicle can be operated longer than in the prior art even with equal battery capacity. This also applies to rail vehicles which draw their energy from an energy carrier in a tank. Vice versa, this means that a smaller (less expensive) battery or less fuel could also be used. The vehicle controller is also capable of supplying information about the performance of the journey to be managed in the event of unpredicted changes of operational procedures (for example, unplanned stops), due to which the operator receives more security about his operational procedures.

The invention will be explained in more detail once again hereinafter on the basis of exemplary embodiments with reference to the appended figures. Identical components are provided with identical reference signs in the different figures. The figures are generally not to scale. In the figures:

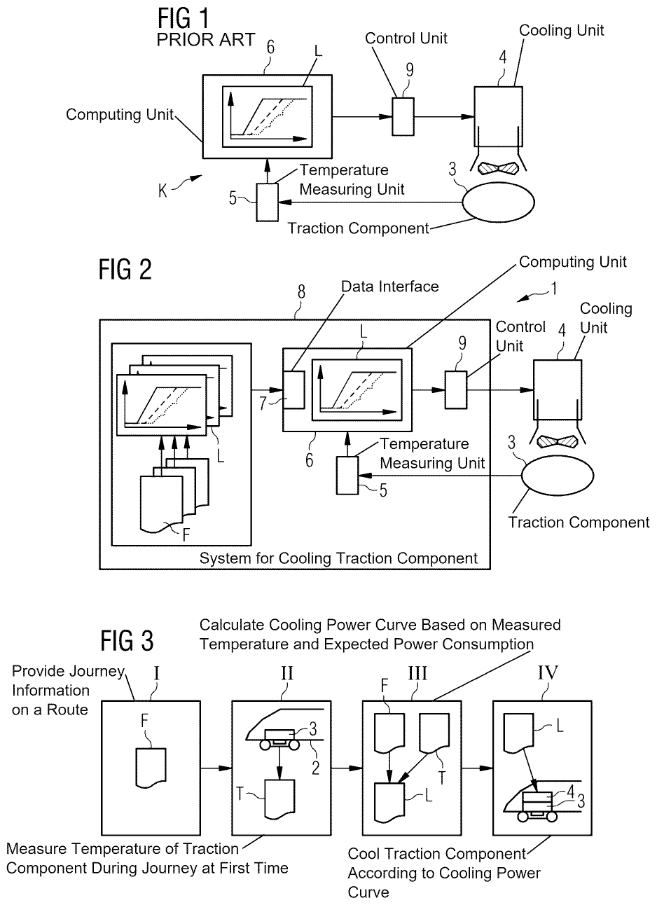

FIG. 1 shows a cooling device for a locomotive according to the prior art,

FIG. 2 shows a cooling system for a locomotive having a system according to the invention, and

FIG. 3 shows a block diagram of an exemplary embodiment of the method according to the invention.

FIG. 1 shows a cooling device K according to the prior art in a very simplified manner. A traction component 3, such as a motor of a locomotive (as an example of a rail vehicle), is cooled as needed by means of a cooling unit 4. A temperature measuring unit 5 measures the temperature of the traction component 3 and passes on the measured data to a computing unit 6. In this example, the computing unit 6 selects a predetermined cooling power curve L based on the measured temperature. The cooling unit 4 is then actuated according to this cooling power curve L and the traction component 3 is cooled accordingly.

FIG. 2 shows a cooling system 1 having a system 8 for cooling a traction component 3 of a locomotive during its journey on a route. The system 8 comprises a data interface 7, a temperature measuring unit 5, a computing unit 6, and a control unit 9. The cooling system additionally comprises a cooling unit 4 of a locomotive.

The data interface 7 is designed to receive journey information F on the route, on which the locomotive is driving or is supposed to drive, and here comprises data on a power consumption of the traction component 3 to be expected during the journey at various times. However, it could also comprise, for example, a route profile having flat areas, downhill gradient routes, and uphill slopes, since the power consumption to be expected can be calculated therefrom. The data interface can be designed, for example, for data transfer with a control center via radio.

The journey information F in the left box indicates here that this is correlated with various cooling power curves L. It can certainly already be specified here which cooling power curve L is to be applied during which route section.

The temperature measuring unit 5 is designed for measuring the temperature of the traction component 3 during the journey at a first time.

The computing unit 6 is designed for calculating a cooling power, which is based on the measured temperature and the power consumption of the traction component 3 to be expected on a section of the route which the locomotive will travel through after the first time. In contrast to FIG. 1, this does not only start from the current temperature, but rather also from a power consumption to be expected.

The control unit 9 is designed to control a cooling unit of the locomotive, specifically using the calculated cooling power.

The system 8 could take into consideration still further measured values. For example, it can also additionally comprise a sensor for measuring the external temperature, wherein the computing unit 6 is then also designed to additionally calculate a cooling power based on a measured external temperature. However, it can also additionally comprise a sensor for measuring energy stored in a battery of the locomotive, wherein the computing unit 6 is then designed to calculate a cooling power additionally based on a measured energy stored in the battery.

FIG. 3 shows a block diagram of an exemplary embodiment of the method according to the invention for cooling a traction component 3 of a locomotive during its journey on a route, for example, using a cooling system 1 as shown in FIG. 2.

In step I, journey information F on the route is provided, which comprises data on a power consumption of the traction component 3 to be expected during the journey at various times or comprises data from which this power consumption to be expected can be calculated. These can be, for example, data on a route profile or on a driving plan.

In step II, the temperature of the traction component 3 is measured during the journey at a first time. Temperature data T are provided here for further processing. In step III, a cooling power curve L is calculated based on the measured temperature (thus the temperature data T) and the power consumption of the traction component 3 to be expected (from the journey information F) on a section of the route through which the locomotive will travel after the first time.

In step IV, the traction component 3 is then cooled according to the calculated cooling power curve L.

Finally, it is once again noted that the methods described in detail above and the system shown are only exemplary embodiments which can be modified by a person skilled in the art in a variety of ways without departing from the scope of the invention. Furthermore, the use of the indefinite articles “a” or “an” does not preclude the relevant features also being able to be present multiple times. The terms “unit” and “device” also do not preclude the relevant components consisting of multiple interacting partial components, which can possibly also be spatially distributed. The expression “a number” is to be understood as “at least one”.

1-15. (canceled)

16. A method for cooling a traction component of a rail vehicle during a journey of the rail vehicle on a route, the method comprising:
providing journey information relating to the route, the journey information including data relating to a power consumption of the traction component to be expected during the journey at various times or including data from which the power consumption to be expected can be calculated, and providing at least data relating to stops or times and durations of standstill times;
measuring a temperature of the traction component during the journey at a first time;
calculating a cooling power based on the measured temperature and the power consumption of the traction component to be expected on a section of the route through which the rail vehicle will travel after the first time, by providing a cooling power curve for a control of the cooling power over a period of time before or during the journey, using data relating to a number of stops and standstill times as journey information and creating the cooling power curve in consideration of cooling during a following standstill time; and
cooling the traction component by using the calculated cooling power.

17. The method according to claim 16, which further comprises using as the journey information at least one of:
data relating to a route profile or inclines, downhill gradients, height, length of a route section, curve radii, or
a driving plan or route-dependent accelerations or decelerations, or
a recommended driving style or a velocity profile, or
a cooling demand required at further times, or
at least one of a trailer load or vehicle cargo, or
meteorological ambient conditions or at least one of wind or temperature, or
energy of an energy carrier still available for the journey of the rail vehicle or a fill level of a tank or a battery.

18. The method according to claim 16, which further comprises:
providing frequency specifications in the cooling power curve for operation of a cooling unit by:
modifying a predetermined cooling power curve based on the journey information and the measured temperature, or
calculating a cooling power curve based on the journey information and the measured temperature and replacing an existing cooling power curve, or
selecting a cooling power curve based on the journey information and the measured temperature from a group of cooling power curves and replacing an existing cooling power curve; and
continuing the cooling of the traction component after the first time according to the cooling power curve.

19. The method according to claim 18, which further comprises creating the cooling power curve to cause the temperature of the traction component after a downtime to correspond to a predetermined target temperature.

20. The method according to claim 19, which further comprises modifying a predetermined cooling power curve to reduce the cooling during the journey and extend the cooling into the downtime.

21. The method according to claim 18, which further comprises using data relating to a route profile as the journey information, identifying route sections requiring a high power output in the route profile and before the route sections, creating a cooling power curve precooling the traction component before reaching a relevant route section, and creating the cooling power curve to cause the temperature of the traction component to be below a predetermined starting temperature before reaching a relevant route section.

22. The method according to claim 21, which further comprises modifying a predetermined cooling power curve to already increase the cooling power before reaching the relevant route section.

23. The method according to claim 18, which further comprises including in the journey information data relating to residual energy still available for the journey and additionally data from which an energy consumption for a further journey is derivable, including data relating to at least one of a route profile or a trailer load or a velocity profile, and creating a cooling power curve to ensure that the available energy is not exceeded before completion of the journey.

24. The method according to claim 23, which further comprises:
calculating which residual energy will still be available at an end of the journey and whether the residual energy falls below a predetermined limiting value; and at least one of:
ascertaining a velocity profile having a lower energy consumption than a velocity profile applied for the journey and applying the ascertained velocity profile for the further journey or outputting the ascertained velocity profile for the further journey as a driving recommendation for a locomotive driver, or
creating a cooling power curve causing a predetermined minimum cooling to take place and thermal reserves of the traction component to be utilized.

25. A system for cooling a traction component of a rail vehicle during a journey of the rail vehicle on a route, the system comprising:
a data interface configured for receiving journey information relating to the route, including data relating to a power consumption of the traction component to be expected during the journey at various times or including data from which the power consumption to be expected can be calculated, and providing at least data relating to stops or times and durations of standstill times;
a temperature measuring unit configured for measuring a temperature of the traction component during the journey at a first time;
a computing unit configured for calculating a cooling power based on the measured temperature and the power consumption of the traction component to be expected on a section of the route through which the rail vehicle will travel after the first time, said computing unit configured to provide a cooling power curve for control of the cooling power over a period of time before or during the journey, to use data relating to a number of stops and standstill times as journey information and to create a cooling power curve in consideration of cooling during a following standstill time; and
a control unit configured for controlling a cooling unit of the rail vehicle to cool the traction component using the calculated cooling power.

26. The system according to claim 25, which further comprises at least one of:
a sensor for measuring an external temperature, said computing unit configured to additionally calculate a cooling power based on the measured external temperature, or
a sensor for measuring energy stored in a battery of the rail vehicle, said computing unit configured to additionally calculate a cooling power based on a measured energy stored in the battery.

27. A cooling system for a rail vehicle being a multiple unit train, a railcar, or a locomotive, the cooling system comprising a cooling unit and a system according to claim 25.

28. A rail vehicle being a multiple unit train, a railcar, or a locomotive, the rail vehicle comprising a cooling system according to claim 27.

29. A non-transitory computer program product, comprising commands which, upon execution of the program by a computer, prompt the computer to carry out the method according to claim 16, and to perform a test journey corresponding to an output of control data for control of a rail vehicle.

30. A non-transitory computer-readable storage medium, comprising commands which, upon execution by a computer, prompt the computer to carry out the method according to claim 16, and to perform a test journey corresponding to an output of control data for control of a locomotive.
